(19) United States
(12) Patent Application Publication
(10) Pub. No.: US 2007/0144668 A1
(43) Pub. Date: Jun. 28, 2007

(54) DOUBLE-SIDE MOUNTING APPARATUS, AND METHOD OF MANUFACTURING ELECTRICAL APPARATUS

(75) Inventors: Yoshitaka Uematsu, Yokohama-shi (JP); Hironori Takabayashi, Yokohama-shi (JP); Sei Musha, Kawasaki-shi (JP); Toshihiko Goshozono, Yokosuka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/533,654

(22) Filed: Sep. 20, 2006

(30) Foreign Application Priority Data
Dec. 27, 2005 (JP) 2005-375971

(51) Int. Cl. B32B 37/00

(52) U.S. Cl. 156/297; 156/580

(57) ABSTRACT

To promote miniaturization of an electronic-component mounted device, in which a larger number of electronic components are mounted on a mounting base, while increasing a number of electronic components mounted on the mounting base, disclosed is a double-side mounting apparatus including: a first compression-bonding tool and a second compression-bonding tool arranged opposite to each other; heating means for heating the first and second compression-bonding tools; pressurizing means for applying a pressure load between the first and second compression-bonding tools; a workpiece retention mechanism for retaining a mounted workpiece in between the first and second compression-bonding tools; a first protective-tape supply mechanism for supplying a first protective tape, in between the first and second compression-bonding tools, to the first compression-bonding tool; and a second protective-tape supply mechanism for supplying a second protective tape, in between the first and second compression-bonding tools, to the second compression-bonding tool.

### CROSS REFERENCE TO RELATED APPLICATION

This application is based upon and claims the benefit of priority from the prior Japanese Patent Application No. 2005-375971, filed on Dec. 27, 2005, the entire content of which is incorporated herein by reference.

### BACKGROUND OF THE INVENTION

1. Field of the Invention

The present invention relates to a double-side mounting apparatus, and a method of manufacturing an electrical apparatus. Particularly, the present invention relates to a double-side mounting apparatus for mounting electronic components on each of both sides of a mounting base, and to a method of manufacturing an electrical apparatus by use of this double-side mounting apparatus.

2. Description of the Related Art

For example, as described in Japanese Patent No. 3355983, a mounting apparatus for manufacturing an electronic-component mounted device by mounting electronic components, such as an IC, an LSI, a resistive element, a capacitive element and the like, on a mounting base such as a substrate. In order to manufacture the electronic-component mounted device, first of all, a mounted tool is prepared where electronic components are temporarily attached to a mounting base with an ACF (Anisotropic Conductive Film) interposed in-between, the AFC being an anisotropic conductive adhesive agent. Then, this mounted tool is placed on a head of the mounting apparatus. Subsequently, the electronic-component mounted device is manufactured by heating the anisotropic conductive adhesive agent while the mounted tool, which is placed on the head, is being pressed to the head by using a compression-bonding head.

However, in the above described mounting apparatus, the following point is not taken into consideration.

In recent years, mounting bases have been miniaturized in accordance with miniaturization of electronic component mounting devices. Accordingly, a mounting space of electronic components on a mounting base becomes smaller. For this reason, in a case where a number of electronic components is increased, it is necessary to make a mounting space larger in accordance with the increase of the electronic components. It is difficult to simultaneously satisfy pursuit of miniaturization of an electronic component, and pursuit of increase in number of mounted electronic components.

### SUMMARY OF THE INVENTION

The present invention is made so as to solve the above described problem, and an object thereof is to provide a double-side mounting apparatus and a double-side mounting method which are capable of increasing a number of electronic components mounted on a mounting base, and, at the same time, capable of promoting miniaturization of an electronic component mounted device in which a large number of electronic components are mounted on a mounting base.

A first characteristic according to one embodiment of the present invention includes in a double-side mounting apparatus: a first compression-bonding tool and a second compression-bonding tool arranged opposite to each other; heating means for heating the first compression-bonding tool and the second compression-bonding tool; pressurizing means for applying a pressure load between the first compression-bonding tool and the second compression-bonding tool; a workpiece retention mechanism for retaining a mounted workpiece between the first compression-bonding tool and the second compression-bonding tool; a first protective-tape supply mechanism for supplying a first protective tape, in between the first compression-bonding tool and the second compression-bonding tool, to the first compression-bonding tool; and a second protective-tape supply mechanism for supplying a second protective tape, in between the first compression-bonding tool and the second compression-bonding tool, to the second compression-bonding tool.

A second characteristic according to the embodiment of the present invention includes, in a method of manufacturing an electrical apparatus, the steps of: temporarily attaching a first electronic component on a front surface of a mounting base with a first anisotropic conductive adhesive agent interposed in-between, and temporarily attaching a second electronic component on a back surface, which is opposite to the front surface of the mounting base, with a second anisotropic conductive adhesive agent interposed in-between; arranging a first protective tape opposite to the first electronic component attached temporarily, and arranging a second protective tape opposite to the second electronic component attached temporarily; and connecting the first electronic component and the second electronic component respectively to both sides of the mounting base by simultaneously pressurizing and heating the first anisotropic conductive adhesive agent with the first protective tape and the first electronic component interposed in-between, and simultaneously pressurizing and heating the second anisotropic conductive adhesive agent through the second protective tape and the second electronic component.

According to the present invention, a number of electronic components mountable on a mounting base can be increased, and furthermore, miniaturization of an electronic component mounted device having electronic devices mounted on a mounting base can be promoted.

### BRIEF DESCRIPTION OF THE DRAWINGS

FIG. 1 is a front view showing an outline of a double-side mounting apparatus according to a first embodiment of the present invention.

FIG. 2 is a side view showing the outline of the double-side mounting apparatus.

FIG. 3A is a side view showing one example of a double-side mounted workpiece used in the double-side mounting apparatus, and FIG. 3B is a side view showing a state where the double-side mounted workpiece is retained by the workpiece retention mechanism.

FIG. 4 is a flowchart explaining steps of double-side mounting.

FIG. 5 is a front view showing the double-side mounting in a state of step S2.

FIG. 6 is a front view showing the double-side mounting in a state of steps S3 and S4.

FIG. 7 is a front view showing the double-side mounting in a state of step S5.

FIG. 8 is a front view showing the double-side mounting in a state of step S6.

FIG. 9 is a front view showing the double-side mounting in a state of step S7.

FIG. 10 is a side view showing an outline of a double-side mounting apparatus according to a second embodiment of the present invention.

FIG. 11 is a side view showing an elevation portion whose self weight is canceled by a self-weight cancellation mechanism.

FIG. 12 is a side view showing a part of the double-side mounting apparatus in a state before pressurization on ICs and ACFs is performed.

FIG. 13 is a side view showing a part of the double-side mounting apparatus in a state where an upper compression-bonding tool makes contact with an upper IC through a protective tape.

FIG. 14 is a side view showing a part of the double-side mounting apparatus in a state where, after the upper compression-bonding tool makes contact with the upper IC with the protective tape interposed in-between, an upper compression-bonding head thereof is further lowered continuously.

FIG. 15 is a side view showing a part of the double-side mounting apparatus in a state where, with the upper compression-bonding head being further lowered continuously, a lower IC makes contact with a lower compression-bonding tool with another protective tape interposed in-between.

### DETAILED DESCRIPTION OF PREFERRED EMBODIMENTS

Embodiments of the present invention will be described below with reference to the drawings.

### First Embodiment

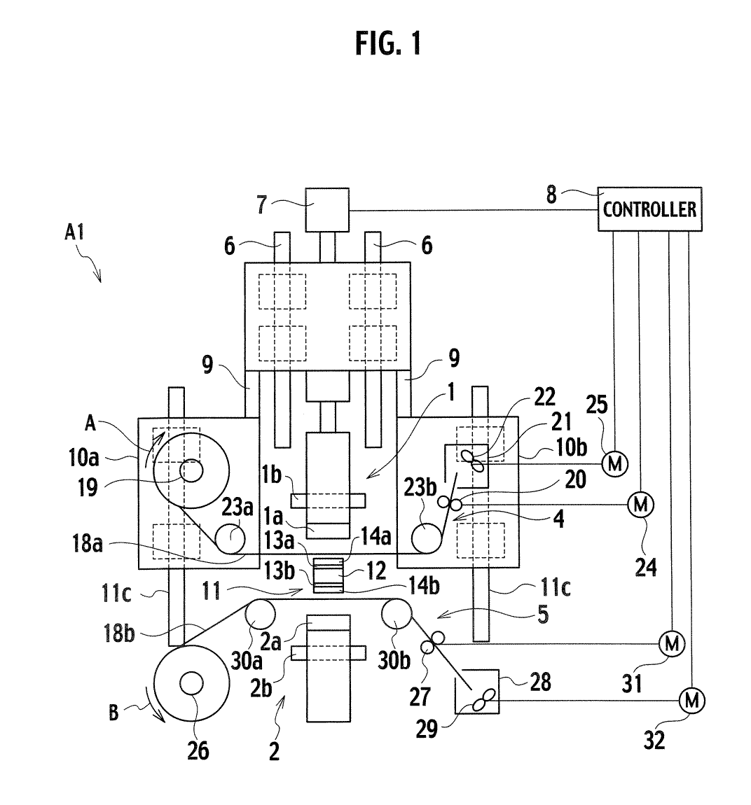

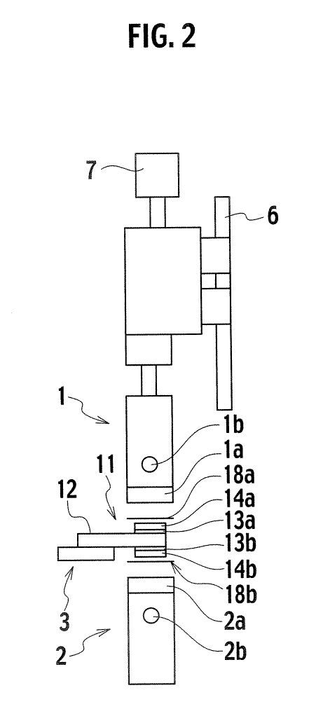

A double-side mounting apparatus Al according to a first embodiment of the present invention is, as shown in FIGS. 1 and 2, provided with: a first compression-bonding tool 1 and a second compression-bonding tool 2 arranged vertically opposite to each other; a workpiece retention mechanism 3; a first protective-tape supply mechanism 4; a second protective-tape supply mechanism 5; and a pair of linear guides 6 extending vertically.

The first compression-bonding tool 1 includes a pressing portion 1a provided in a position facing the second compression-bonding tool 2, and a heater 1b which is heating means. The pressing portion 1a and the heater 1b are situated in positions allowing heat produced by the heater 1b to be transmitted to the pressing portion 1a.

The first compression-bonding tool 1 is attached so as to be vertically movable along the linear guides 6. To the first compression-bonding tool 1, a vertical-movement driving unit 7 is coupled which causes the first compression-bonding tool 1 to vertically move along the linear guides 6. As the vertical-movement driving unit 7, an air cylinder, an oil hydraulic cylinder, a stepping motor or the like can be used. The vertical-movement driving unit 7 is connected to a controller 8 which controls this vertical-movement driving unit 7. This vertical-movement driving unit 7 works also as pressurizing means for applying a pressure load between the first and second compression-bonding tools 1 and 2.

A pair of frames 10a and 10b is coupled to the first compression-bonding tool 1 by means of a coupling bar 9. The frames 10a and 10b are movably attached to a linear guide 11c extending vertically. The linear guide 11c is arranged parallel to the linear guides 6. When the first compression-bonding tool 1 makes a vertical movement by being driven by the vertical-movement driving unit 7, the frames 10a and 10b make a vertical movement together with the movement of the first compression-bonding tool 1.

The second compression-bonding tool 2 includes a pressing portion 2a provided in a position facing the first compression-bonding tool 1 and a heater 2b which is a heating means. The pressing portion 2a and the heater 2b are situated in positions allowing heat produced by the heater 2b to be transmitted to the pressing portion 2a. This second compression-bonding tool 2 is fixed to a base not illustrated.

The workpiece retention mechanism 3 retains a mounted workpiece 11 between the pressing portion 1a of the first compression-bonding tool 1 and the pressing portion 2a of the second compression-bonding tool 2. To the workpiece retention mechanism 3, a mechanism (not illustrated) is provided which enables the mounted workpiece 11 retained by the workpiece retention mechanism 3 to move vertically about an initial position (an intermediate position of the first and second compression-bonding tools 1 and 2 before the first compression-bonding tool 1 is driven).

The mounted workpiece 11 is constituted by temporarily attaching an IC 14a, which is a first electronic component, onto a front surface of a mounting base 12 with an ACF 13a which is a first anisotropic conductive adhesive agent interposed in-between, and temporarily attaching an IC 14b, which is a second electronic component, onto a back surface of the mounting base 12 which is opposite to the front surface thereof, with an ACF 13b which is a second anisotropic conductive adhesive agent interposed in-between.

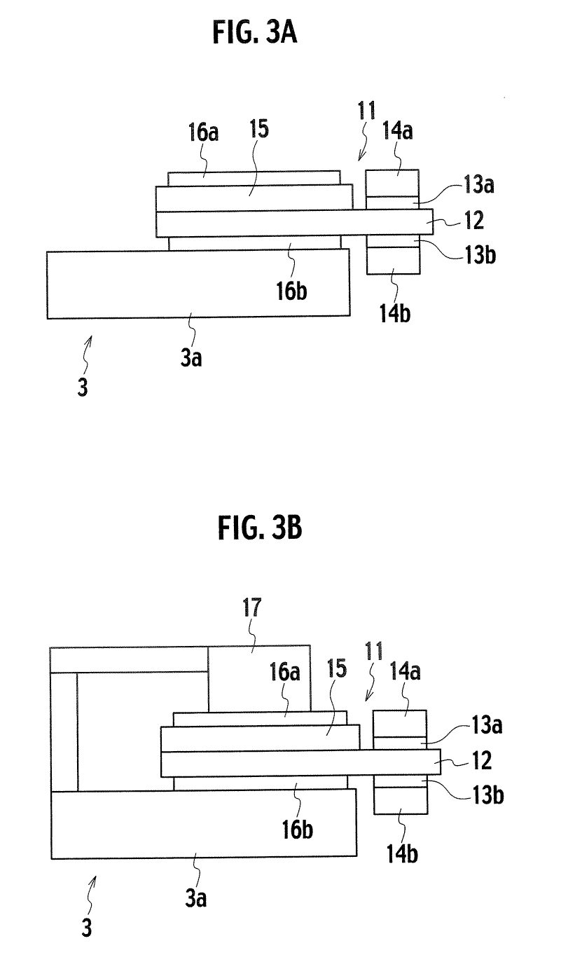

FIG. 3 shows a liquid crystal display as an example of the mounted workpiece 11. In this liquid crystal display, the IC 14a is temporarily attached onto the front surface of the mounting base (glass substrate) 12 with the ACF 13a interposed in-between, and the IC 14b is temporarily attached onto the back surface of the mounting base 12 with the ACF 13b interposed in-between. Furthermore, a glass substrate 15 is joined onto the front surface of the mounting base 12, a deflection plate 16a is joined onto this glass substrate 15, and a deflection plate 16b is joined onto the back surface of the mounting base 12.

As a method for having the workpiece retention mechanism 3 retain the mounted workpiece 11, as shown in FIG. 3A, any one of methods can be adopted: the method in which the deflection plate 16b is sucked and attached by a retention stage 3a which is a part of the workpiece retention mechanism 3; and the method in which the mounted workpiece 11 is clamped by a workpiece clamp 17 attached to the retention stage 3a.

The first protective-tape supply mechanism 4 is provided with: a first retention shaft 19 which is a first retention unit for retaining a first protective tape 18a wound into a rolled state; a first delivery roller 20 which is a first supply unit for pulling the first protective tape 18a out of the rolled state to supply the first protective tape 18a to a supply position; a first suction fan 22 which is a first suction unit for sucking into the first containing case 21 the first protective tape 18a having been supplied; and a pair of guide rollers 23a and 23b. A driving motor 24 is coupled to the first delivery roller 20, a driving motor 25 is coupled to the first suction fan 22, and those motors 24 and 25 are connected to the controller 8.

The first retention shaft 19 and the guide roller 23a are attached to the frame 10a on one side, and the guide roller 23b, the first delivery roller 20, the first containing case 21, and the first suction fan 22 are attached to the frame 10b on the other side. Thereby, when the first compression-bonding tool 1 moves vertically together with the frames 10a and 10b by being driven by the vertical-movement driving unit 7, the first protective-tape supply mechanism 4 also integrally moves vertically with that movement. A mechanism (not illustrated) for allowing only the guide rollers 23a and 23b to move vertically is coupled to the guide rollers 23a and 23b. To the first retention shaft 19, a torque limiter mechanism (not illustrated) is provided which adds torque in a direction (a direction of an arrow A shown in FIG. 1) of rewinding the first protective tape 18a retained thereby, and thus prevents the loosening of the first protective tape 18a which is pulled out of the rolled state.

The first protective-tape supply mechanism 4 supplies, in between the first and second compression-bonding tools 1 and 2, the first protective tape 18a to the first compression-bonding tool 1. In a case where the mounted workpiece 11 retained by the workpiece retention mechanism 3 is positioned between the first and second compression-bonding tools 1 and 2, the protective tape 18a is supplied between the first compression-bonding tool 1 and the mounted workpiece 11.

The first protective tape 18a is a continuous tape which is formed of Teflon (trademark) and is wound into a rolled state. The first protective tape 18a is pulled out of the rolled state, and is supplied between the first compression-bonding tool 1 and the mounted workpiece 11, and thereby it prevents the ACF 13a, which squeezes out when, as will be described later, the mounted workpiece 11 positioned between the first and second compression-bonding tools 1 and 2 is pressed by the first and second compression-bonding tools 1 and 2, from adhering to the pressing portion 1a of the first compression-bonding tool 1 at that time. Additionally, the first protective tape 18a prevents the IC 14a from making contact with the pressing portion 1a which is metallic. Furthermore, the first protective tape 18a functions as a cushion material equalizing a pressure load acting upon the IC 14a of the mounted workpiece 11 from the first compression-bonding tool 1.

In the first protective-tape supply mechanism 4, the first protective tape 18a retained by the first retention shaft 19 is pulled out of the rolled state by the drive of the first delivery roller 20. The first protective tape 18a being pulled out of the rolled state is temporarily stopped between the first compression-bonding tool 1 and the mounted tool 11 due to a temporal stoppage of the driving of the first delivery roller 20. This first protective tape 18a is sandwiched between the pressing portion 1a of the first compression-bonding tool 1 and the IC 14a of the mounted workpiece 11 when the mounted workpiece 11 is pressurized. After completion of the pressurizing of the mounted workpiece 11, the first protective tape 18a is delivered to the first containing case 21 by the resumed drive of the first delivery roller 20 in the same direction. The first protective tape 18a passes a position of the first delivery roller 20, and then is housed into the first containing case 21 by being pulled in by the first suction fan 22.

The second protective-tape supply mechanism 5 is provided with: a second retention shaft 26 which is a second retention unit for retaining a second protective tape 18b wound into a rolled state; a second delivery roller 27 which is a second supply unit for pulling the second protective tape 18b out of the rolled state to supply the second protective tape 18b to a supply position; a second suction fan 29 which is a second suction unit for sucking into the second containing case 28 the second protective tape 18b having been supplied; a pair of guide rollers 30a and 30b. A driving motor 31 is coupled to the second delivery roller 27, a driving motor 32 is coupled to the second suction fan 29, and those motors 31 and 32 are connected to the controller 8.

The second retention shaft 26, the second delivery roller 27, the second containing case 28, the second suction fan 29, and the guide rollers 30a and 30b are attached a base to which the second compression-bonding tool 2 is attached. A mechanism (not illustrated) for allowing only the guide rollers 30a and 30b to move vertically is coupled to the guide rollers 30a and 30b. To the second retention shaft 26, a torque limiter mechanism (not illustrated) is provided, which adds torque in a direction (a direction of an arrow B shown in FIG. 1) of rewinding the second protective tape 18b retained thereby, and thus prevents the loosening of the second protective tape 18b which is pulled out of the rolled state.

The second protective-tape supply mechanism 5 supplies, in between the first and second compression-bonding tools 1 and 2, the second protective tape 18b to the second compression-bonding tool 2. In a case where the mounted workpiece 11 retained by the workpiece retention mechanism 3 is positioned between the first and second compression-bonding tools 1 and 2, the protective tape 18b is supplied between the second compression-bonding tool 2 and the mounted workpiece 11.

The second protective tape 18b is a continuous tape which is formed of Teflon (trademark) and is wound into a rolled state. The second protective tape 18b is pulled out of the rolled state, and is supplied between the second compression-bonding tool 2 and the mounted workpiece 11, and thereby it prevents the ACF 13b, which squeezes out when, as will be described later, the mounted workpiece 11 positioned between the first and second compression-bonding tools 1 and 2 is pressed by the first and second compression-bonding tools 1 and 2, from adhering to the pressing portion 2a of the second compression-bonding tool 2. Additionally, the second protective tape 18b prevents the IC 14b from making contact with the pressing portion 2a which is metallic. Furthermore, the second protective tape 18b functions as a cushion material equalizing a pressure load acting upon the IC 14b of the mounted workpiece 11 from the second compression-bonding tool 2.

In the second protective-tape supply mechanism 5, the second protective tape 18b retained by the second retention shaft 26 is pulled out of the rolled state by the drive of the second delivery roller 27. The second protective tape 18b being pulled out of the rolled state is temporarily stopped between the second compression-bonding tool 2 and the mounted tool 11 due to a temporal stoppage of the driving of the second delivery roller 27. This second protective tape 18b is sandwiched between the pressing portion 2a of the second compression-bonding tool 2, and the IC 14b of the mounted workpiece 11, when the mounted workpiece 11 is pressurized. After completion of pressurizing the mounted workpiece 11, the second protective tape 18b is delivered to the second containing case 28 by the resumed drive of the second delivery roller 27 in the same direction. The second protective tape 18b passes a position of the second delivery roller 27, and then is contained into the second containing case 28 by being pulled in by the second suction fan 29.

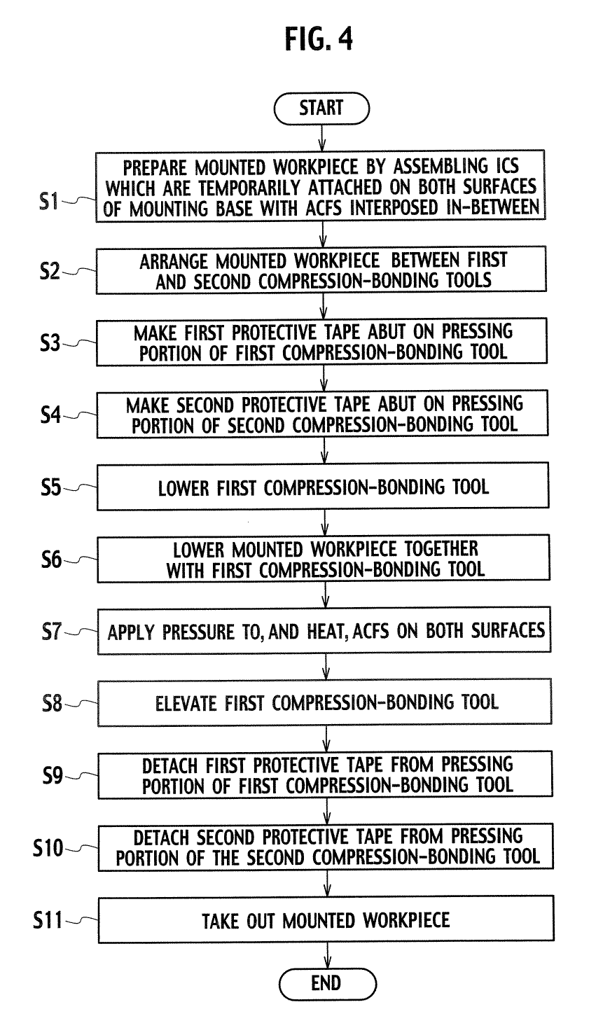

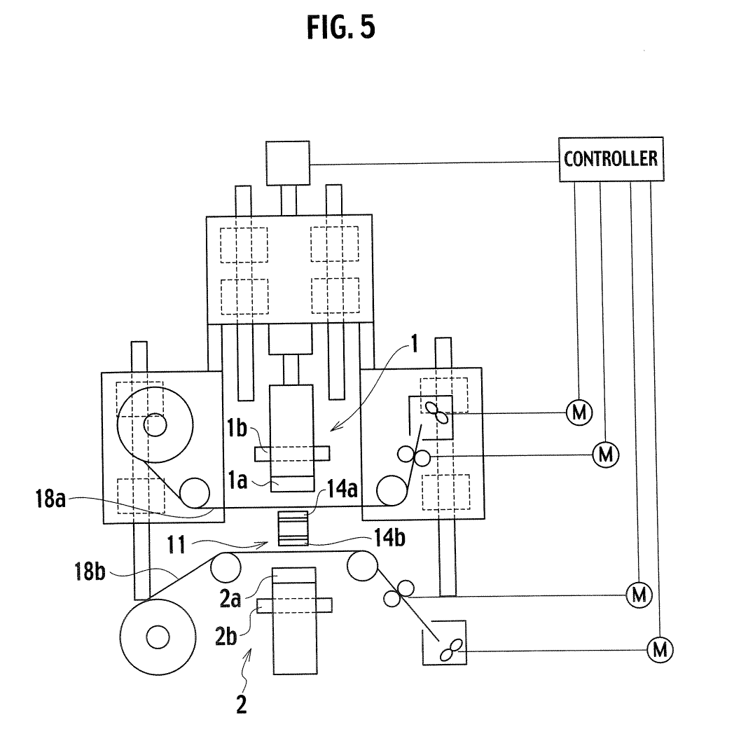

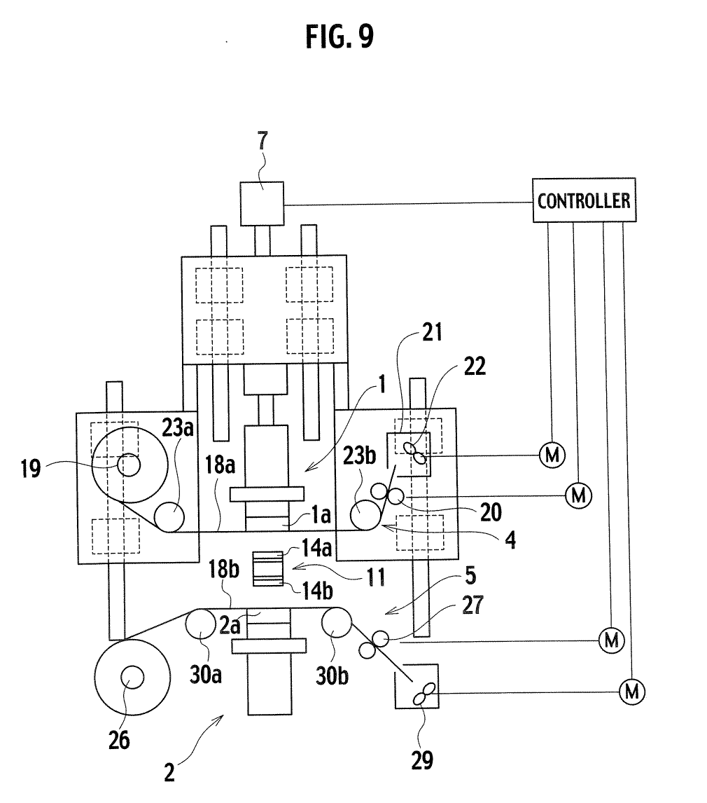

A double-side mounting method using the double-side mounting apparatus Al will be described based on a flowchart in FIG. 4, and also based on FIGS. 5 and 9.

First of all, the mounted workpiece 11 is prepared in which the IC 14a is temporarily attached on the front surface of the mounting base 12 with the ACF13a interposed in-between, and the IC 14b is temporarily attached on the back surface of the mounting base 12, which is opposite to the front surface, with the ACF13b (S1) interposed in-between.

The mounted workpiece 11 thus prepared is arranged between the first and second compression-bonding tools 1 and 2 by being retained by the workpiece retention mechanism 3, the IC 14a is faced to the first protective tape 18a, and the IC 14b is faced to the second protective tape 18b (S2). FIG. 5 is a front view showing a state of this step S2. In this step S2, the first protective tape 18a is positioned apart from the pressing portion 1a of the first compression-bonding tool 1, and the second protective tape 18b is positioned apart from the pressing portion 2a of the second compression-bonding tool 2. Thereby, heat from the heaters 1b and 2b is prevented from being transmitted to the first and second protective tapes 18a and 18b through the pressing portions 1a and 1b, whereby the first and second protective tapes 18a and 18b are prevented from being contracted or deformed by the heat before pressurization by the first and the second compression-bonding tools 1 and 2 is applied thereto.

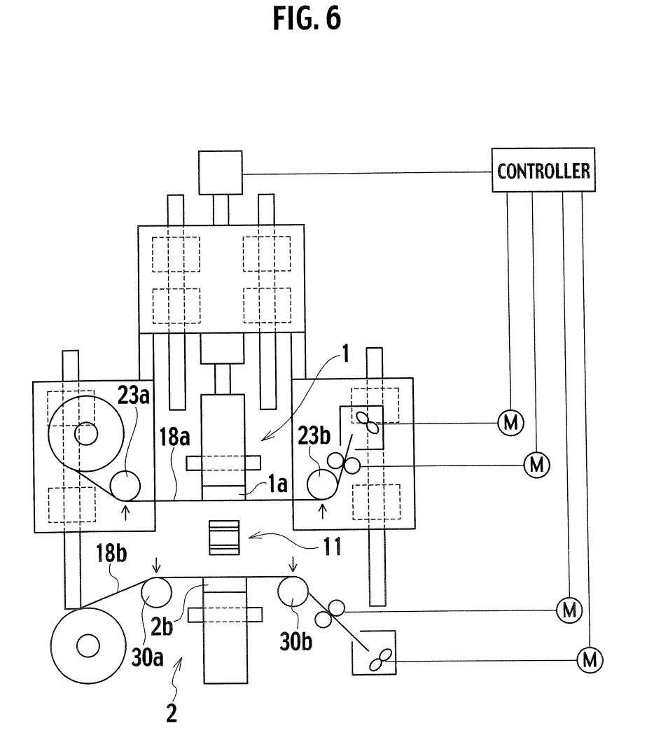

After the mounted workpiece 11 is arranged between the first and second compression-bonding tools 1 and 2 with the first and second protective tapes 18a and 18b interposed in-between the mounted workpiece 11 and each of the first and second compression-bonding tools 1 and 2, the first protective tape 18a is abutted against the pressing portion 1a of the first compression-bonding tool 1 by the elevation of the guide rollers 23a and 23b (S3). Furthermore, by lowering the guide rollers 30a and 30b, the second protective tape 18b is abutted against the pressing portion 2a of the second compression-bonding tool 2 (S4). FIG. 6 is a front view showing a state of these steps 3 and 4.

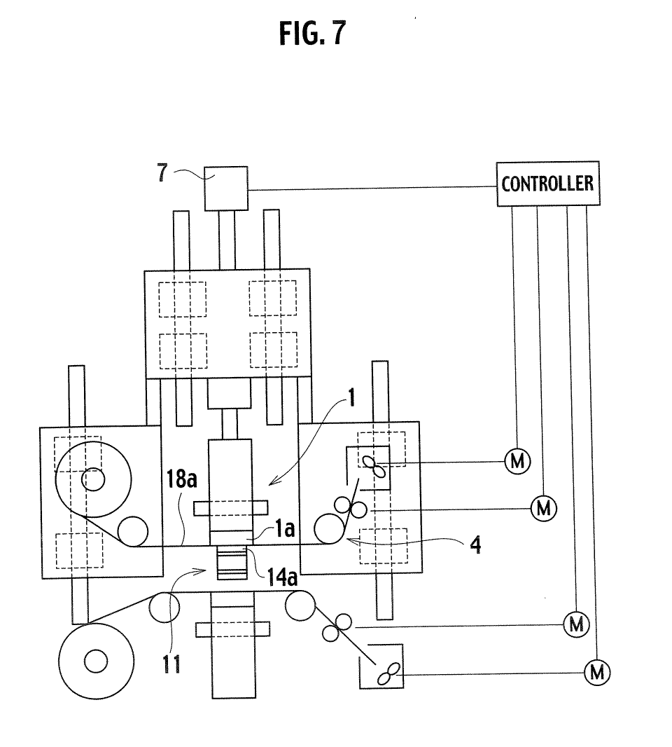

After completion of steps S3 and S4, the first compression-bonding tool 1 is lowered by the drive of the vertical-movement driving unit 7 (S5). At this time, the first protective tape supply mechanism 4 and the first protective tape 18a are lowered integrally therewith. FIG. 7 is a front view showing a state where the first compression-bonding tool is lowered, and the pressing portion 1a is lowered to the IC 14a of the mounted workpiece 11 with the first protective tape 18a interposed in-between.

When the first protective tape 18a is pressed against the IC 14a, the first protective tape 18a has already been abutted against the pressing portion 1a. At this time, a positional relation between the first protective tape 18a and the pressing portion 1a is stable. Therefore, when the first protective tape 18a is pressed against the IC 14a, an incident where a tensile force from the pressing portion 1a acts upon the first protective tape 18a does not occur. Therefore, lateral misalignment of the first protective tape 18a due to such a tensile force does not occur, and misalignment of the temporarily attached IC 14a due to the lateral misalignment of the first protective tape 18a does not occur.

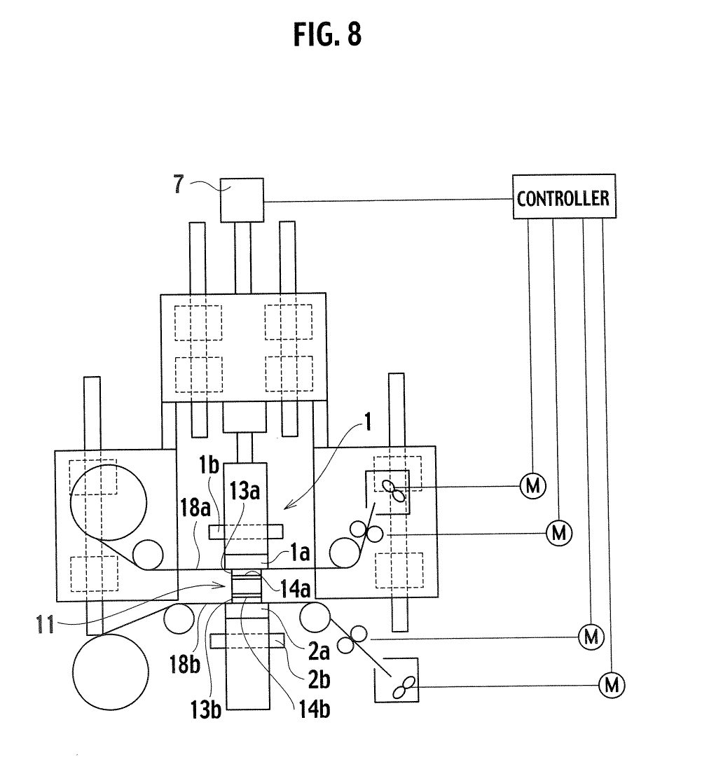

After the pressing portion 1a of the first compression-bonding tool 1 is pressed against the IC 14a with the first protective tape 18a interposed in-between by the first compression-bonding tool 1 being lowered, the first compression-bonding tool 1 is further lowered continuously. By the further continuous lowering of the first compression-bonding tool 1 continuously, the first compression-bonding tool 1 downwardly pushes the mounted workpiece 11 being retained by the workpiece retention mechanism 3, whereby the mounted workpiece 11 is lowered integrally with the first compression-bonding tool 1 (S6). FIG. 8 is a front view showing a state where the mounted workpiece 11 having been lowered is pressed against the pressing portion 2a of the second compression-bonding tool 2 with the second protective tape 18b interposed in-between.

After the IC 14a and IC 14b of the mounted workpiece 11 are sandwiched in a vertical direction with the mounted workpiece 11, which has been lowered to a position shown in FIG. 8, the vertical-movement driving unit 7 is driven continuously. Thereby, while the ACF 13a is pressurized through the IC 14a, heat of the heater 1b is transmitted to the AFC 13a through the pressing portion 1a and the IC 14a, whereby the ACF 13a is pressurized and heated. At the same time, while the ACF 13b is pressurized through the IC 14b, heat of the heater 2b is transmitted to the AFC 13b through the pressing portion 1b and the IC 14b, whereby the ACF 13b is pressurized and heated (S7). An outward appearance of step S7 is the same as that shown in FIG. 8. By pressurization and heating in step S7, the ACFs 13a and 13b undergo thermal curing reaction, whereby the ICs 14a and 14b which have been temporarily attached are mounted on the mounting base 12.

Consequently, mounting spaces can be secured on both sides of the mounting base 12 in the mounted workpiece 11, and, even in a case where a number of electronic components (for example, the ICs 14a and 14b) mounted on the mounting base 12 is increased, a large number of electronic components can be mounted without increasing a size of the mounting base 12. Thereby, a number of electronic components can be increased with miniaturization of the mounted workpiece 11 being promoted.

Additionally, according to this mounting method, substantially the same levels of pressure and heat can be applied to the ACFs 13a and 13b used for mounting the ICs 14a and 14b on one of both sides of the mounting base 12, whereby insufficient pressurization and excessive pressurization, and insufficient heating and excessive heating, can be prevented.

Furthermore, according to this mounting method, a time required for mounting electronic components can be made substantially the same as a time required for mounting them only on one side of the mounting base 12.

After pressurizing and heating the ACFs 13a and 13b for a predetermined time period by means of the first and second compression-bonding tools 1 and 2, the first compression-bonding tool 1 is elevated together with the first protective-tape supply mechanism 4 by the drive of the vertical-movement driving unit 7 (S8). Along with the elevation of the first compression-bonding tool 1, the mounted tool 11 which is retained by the mechanism enabling the mounted workpiece 11 to move vertically, is elevated with the first compression-bonding tool 1, and the IC 14b becomes apart from the second protective tape 18b. After the mounted workpiece 11 is elevated to an initial position (a position shown in FIGS. 6 and 7) with the first compression-bonding tool 1, only the first compression-bonding tool 1 is elevated further because the elevation of the mounted workpiece 11 stops, whereby the first protective tape 18a becomes apart from the IC 14a. FIG. 9 is a front view showing a state where the first and second protective tapes 18a and 18b are apart from the ICs 14a and 14b, respectively.

As shown in FIG. 9, after the second protective tape 18b becomes apart from the IC 14b, and the first protective tape 18a becomes apart from the IC 14a, the first protective tape 18a is made apart from the pressing portion 1a of the first compression-bonding tool 1 by the lowering of the guide rollers 23a and 23b (S9). Then, by elevating the guide rollers 30a and 30b, the second protective tape 18b is made apart from the pressing portion 2a of the second compression-bonding tool 2 (S10). Thereafter, the mounted workpiece 11 is taken out of between the first and second compression-bonding tools 1 and 2 (S11), whereby a series of mounting operations is ended.

After the mounted workpiece 11 is taken out of between the first and second compression-bonding tools 1 and 2, the first and second delivery rollers 20 and 27, and the first and second suction fans 22 and 29 are driven. A used part used for compression bonding in the first protective tape 18a is delivered to the first containing case 21 by the drive of the first delivery roller 20. The first protective tape 18a delivered to the first containing case 21 is sucked into, and contained inside, the first containing case 21. As the used part in the first protective tape 18a is delivered to the first containing case 21 by the drive of the first delivery roller 20, the first protective tape 18a being retained by the first retention shaft 19 is pulled out along with that operation. Then, an unused part in the first protective tape 18a moves in between the first and second compression-bonding tools 1 and 2, and waits for a next compression-bonding operation.

A used part used for compression bonding in the second protective tape 18b is delivered to the second containing case 28 by the drive of the second delivery roller 27. The second protective tape 18b having been delivered to the second containing case 27 is sucked into, and contained inside, the second containing case 28. As the used part in the second protective tape 18b is delivered to the second containing case 28 by the drive of the second delivery roller 27, the second protective tape 18b being retained by the second retention shaft 26 is pulled out along with that operation. Then, an unused part in the second protective tape 18b moves in between the first and second compression-bonding tools 1 and 2, and waits for a next compression-bonding operation.

According to the double-side mounting apparatus A1, the first and second protective tapes 18a and 18b, after used, are sucked into, and contained inside, the first containing case 21 and the second containing case 28, respectively. Accordingly, mechanisms for winding up the used first and second protective tapes 18a and 18b become unnecessary, whereby devices for containing the used first and second protective tapes 18a and 18b can be simplified. Furthermore, after the used first and second protective tapes 18a and 18b contained inside the first and second containing cases 21 and 28 are taken out of the first and second containing cases 21 and 28, and discarded, troubles, such as labor which would otherwise be required for wrapping foreparts of the first and second protective tapes 18a and 18b around respective winding shafts inside the first and second containing cases, is unnecessary. Accordingly, troubles occurring after the first and second protective tapes 18a and 18b after being used are taken out of the first and second containing cases 21 and 28, and discarded, can be reduced.

### Second Embodiment

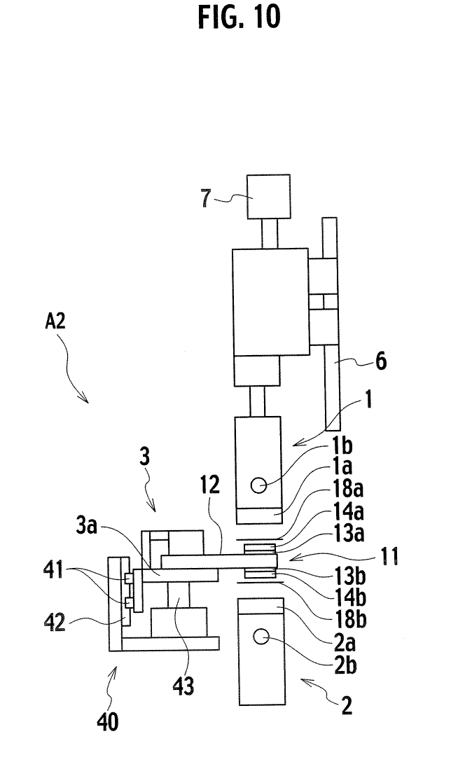

A double-side mounting apparatus A2 according to a second embodiment of the present invention will be described based on FIGS. 10 to 15. Note that the same reference numerals refer to the same elements described in the first embodiment, and duplicated explanations are omitted.

A basic configuration of the double-side mounting apparatus A2 according to the second embodiment is the same as that of the double-side mounting apparatus Al according to the first embodiment. A difference between the double-side mounting apparatus A2 according to the second embodiment and the double-side mounting apparatus A1 according to the first embodiment is that a workpiece retention mechanism 3 in the double-side mounting apparatus A2 according to the second embodiment is provided with a self-weight gravity cancellation mechanism 40 for canceling a self weight of a mounted workpiece 11 retained thereby. Note that, as the self weight cancelled by the self-weight cancellation mechanism 40, self weights of members which retain the mounted workpiece 11 and move together with the mounted workpiece 11 are included in addition to the self weight of the mounted workpiece 11.

A linear guide 41 is coupled to a retention stage 3a constituting a part of the workpiece retention mechanism 3. This linear guide 41 is fitted to a guide rail 42, which extends vertically, so as to be slidable on the guide rail 42. An air cylinder 43 is coupled to a downside of a retention stage 3a. An electropneumatic regulator which is not illustrated is connected to an air cylinder 43, and it is made possible to set a pressure of air, which is supplied to the air cylinder 43 from the electropneumatic regulator, to an arbitrary pressure. The self-weight cancellation mechanism 40 is constituted by including the air cylinder 43, the electropneumatic regulator, and the linear guide 41.

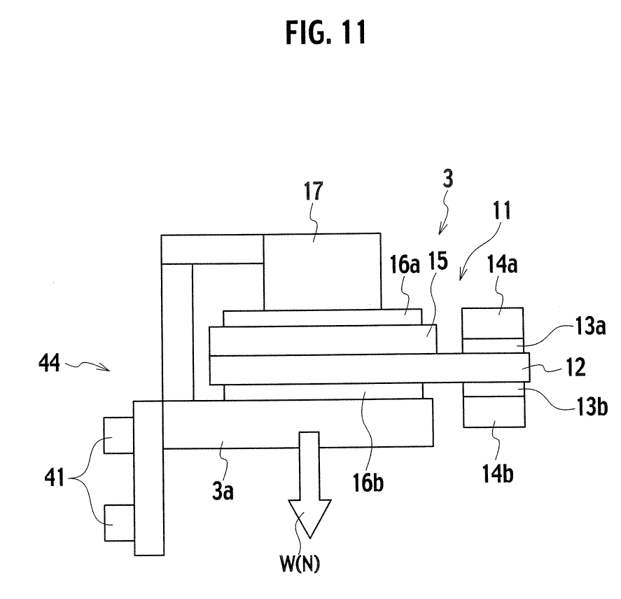

FIG. 11 is a side view showing an elevation portion 44 whose self weight is canceled by the self-weight cancellation mechanism 40. A self weight W (N) of the elevation portion 44 is a value obtained by adding up a self weight of the retention stage 3a, a self weight of the linear guide 41, a self weight of a workpiece clamp 17, and a self weight of the mounted workpiece 11.

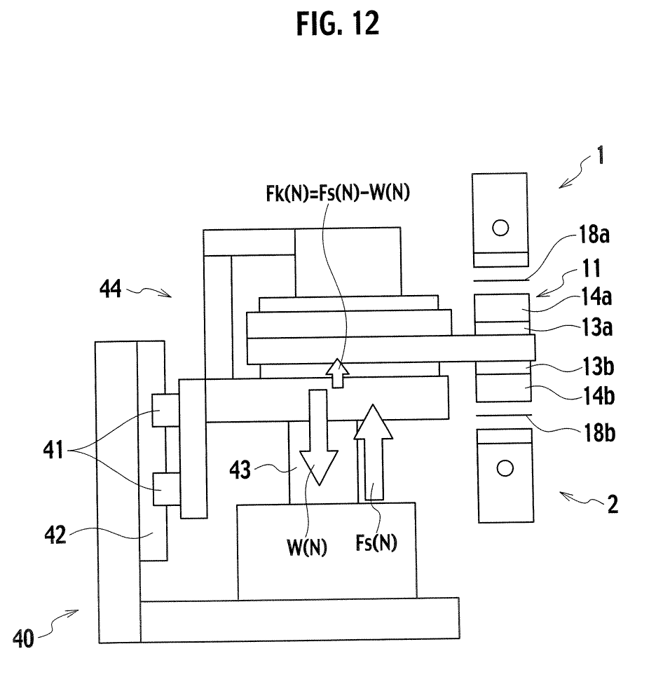

FIG. 12 shows a state before the pressurization against ACFs 13a and 13b is performed. A force of W (N) acts downwardly upon the elevation portion 44. Therefore, with this force of W (N), the elevation portion 44 is ready to move downwardly. In response, by supplying a predetermined air pressure to the air cylinder 43, an upward thrust force Fs (N) is caused to act from the air cylinder 43.

At this time, an upward force Fk (N) acting upon the elevation portion 44 is: Fk (N)=Fs (N)−W (N). If the pressure supplied to Fs (N) is adjusted so as to make Fs (N)=W (N), this makes Fk (N)=0 (N), thereby making it possible to cancel the self weight of the elevation portion 44.

For convenience, this state is expressed as a self-weight cancellation state. In the self-weight cancellation state, the elevation portion 44 is in a floating state moving neither upward nor downward.

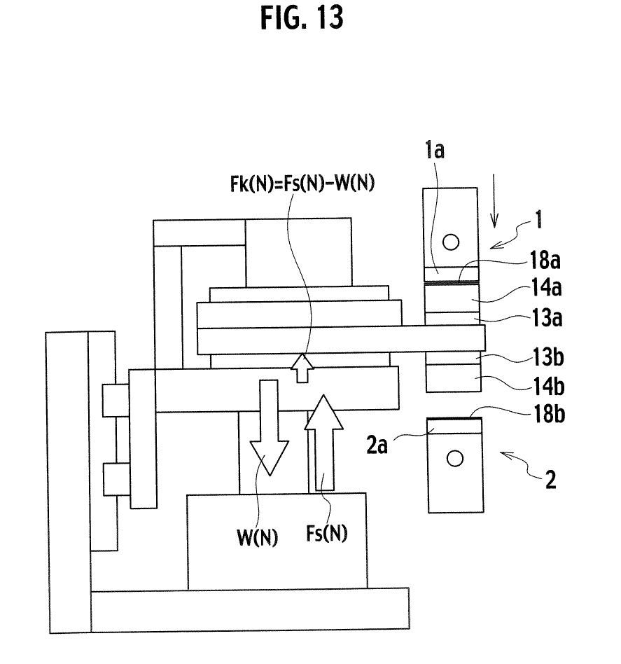

FIG. 13 shows a state where the pressing portion 1a makes contact with the IC 14a of the mounted workpiece 11 with the first protective tape 18a interposed in-between, with the first compression-bonding tool 1 having been lowered. Note that the pressing portion 1a and the IC 14a only make contact with each other, and this is a state where a downward force is not acting upon the IC 14a from the first compression-bonding tool 1.

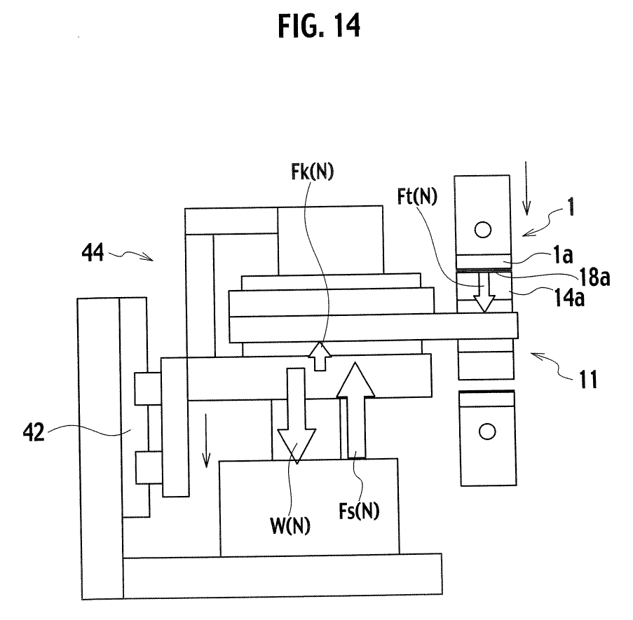

FIG. 14 shows a state where, after the pressing portion 1a makes contact with the IC 14a of the mounted workpiece 11 through the first protective tape 18a, the compression-bonding tool 1 is further lowered continuously. At this time, a downward force Ft (N) acts upon the mounted tool 11 from the first compression-bonding tool 1. Then, the elevation portion 44 slides downward along the guide rail 42. However, a condition for enabling an entirety of the elevation portion 44 to slide downward is the one that satisfies Ft (N)>Fs (N)−W (N)=Fk (N).

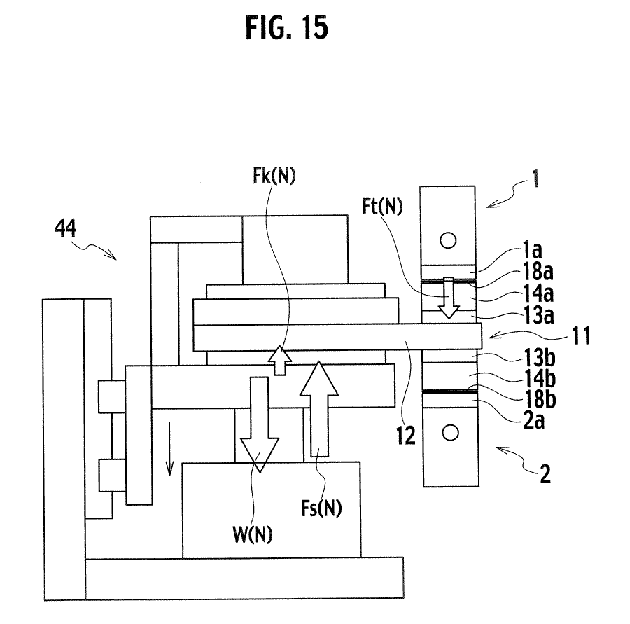

FIG. 15 shows a state where, with the first compression-bonding tool 1 having been further lowered continuously from the state shown in FIG. 14, the IC 14b of the mounted workpiece 11 makes contact with the pressing portion 2b of the second compression-bonding tool 2 with the second protective tape 18b interposed in-between. In this state, the ICs 14a and 14b are sandwiched between the first and second compression-bonding tools 1 and 2, and go into a pressurized state. This pressure load acts upon the upper and lower ACFs 13a and 13b, and the ACFs 13a and 13b undergo thermal curing reaction by having pressure and heat acting upon the ACFs 13a and 13b. Thereby, the mounting of the ICs 14a and 14b by use of the ACFs 13a and 13b is completed. Note, however, that forces acting upon the ACFs 13a and 13b are, more strictly, as follows.

A force acting upon the ACF 13a is Ft (N)+Fk (N), and

a force acting upon the ACF 13b is Ft (N)−Fk (N).

According to these two equations, it can be found that different pressure loads act upon the respective upper and lower ACFs 13a and 13b. However, more equal levels of thermal curing reaction can be obtained in the respective ACFs 13a and 13b with more equal pressure loads and temperatures in upper and lower compression-bonding conditions. Therefore, the closer the upper and lower pressure loads are to each other, the better. Accordingly, in order to cause equivalent forces to act upon the respective upper and lower ACFs 13a and 13b, it is desirable to have a state where Fk (N)−0, i.e., Fs (N)−W (N). That is, this is a state where a self weight of the elevation portion 44 is canceled. Also in this context, it becomes necessary to provide the self-weight cancellation mechanism 40 shown in FIG. 10.

Additionally, in a case where Fk (N)≠0, a shearing force of Fk (N) comes to act upon the mounting base 12 in the state shown in FIG. 15. When Fk (N) is large, the force can destroy the mounting base 12 in some cases. Also from this regard, it is necessary to provide a mechanism for making Fk (N)−0, i.e., the self-weight cancellation mechanism 40.

What is claimed is:

1. A double-side mounting apparatus comprising:
a first compression-bonding tool and a second compression-bonding tool arranged opposite to each other;
heating means which heats the first compression-bonding tool and the second compression-bonding tool;
pressurizing means which applies a pressure load between the first compression-bonding tool and the second compression-bonding tool;
a workpiece retention mechanism for retaining a mounted workpiece in between the first compression-bonding tool and the second compression-bonding tool;
a first protective-tape supply mechanism for supplying a first protective tape, in between the first compression-bonding tool and the second compression-bonding tool, to the first compression-bonding tool; and
a second protective-tape supply mechanism for supplying a second protective tape, in between the first compression-bonding tool and the second compression-bonding tool, to the second compression-bonding tool.

2. The double-side mounting apparatus according to claim 1, wherein
the workpiece retention mechanism comprises a self-weight cancellation mechanism for canceling a self weight of the mounted workpiece retained thereby.

3. The double-side mounting apparatus according to claim 1, wherein
the first protective-tape supply mechanism comprises: a first supply unit for supplying the first protective tape; and a first suction unit for sucking into a first containing case the first protective tape having been supplied, and
the second protective-tape supply mechanism comprises: a second supply unit for supplying the second protective tape; and a second suction unit for sucking into a second containing case the second protective tape having been supplied.

4. The double-side mounting apparatus according to claim 2, wherein
the first protective-tape supply mechanism comprises: a first supply unit for supplying the first protective tape; and a first suction unit for sucking into a first containing case the first protective tape having been supplied, and
the second protective-tape supply mechanism comprises: a second supply unit for supplying the second protective tape; and a second suction unit for sucking into a second containing case the second protective tape having been supplied.

5. A method of manufacturing an electrical apparatus, comprising the steps of:
temporarily attaching a first electronic component on a front surface of a mounting base with a first anisotropic conductive adhesive agent interposed in-between, and temporarily attaching a second electronic component on a back surface of the mounting base, which is opposite to the front surface thereof, with a second anisotropic conductive adhesive agent interposed in-between;
arranging a first protective tape opposite to the first electronic component attached temporarily, and arranging a second protective tape opposite to the second electronic component attached temporarily; and
connecting the first electronic component and the second electronic component respectively to both sides of the mounting base by simultaneously pressurizing and heating the first anisotropic conductive adhesive agent, through the first protective tape and the first electronic component, and simultaneously pressurizing and heating the second anisotropic conductive adhesive agent, with the second protective tape and the second electronic component.
